(19) United States
(12) Patent Application Publication
(10) Pub. No.: US 2016/0012984 A1
(43) Pub. Date: Jan. 14, 2016

(54) INHERENTLY FAIL-SAFE CIRCUIT BREAKER ASSEMBLY

(71) Applicant: John K. Grady, Ayer, MA (US)

(72) Inventor: John K. Grady, Ayer, MA (US)

(21) Appl. No.: 14/796,051

(22) Filed: Jul. 10, 2015

Related U.S. Application Data
(60) Provisional application No. 62/023,351, filed on Jul. 11, 2014.

(51) Int. Cl. H01H 9/10; H01H 89/06; H01H 9/18

(52) U.S. Cl. CPC H01H 9/10; H01H 9/18; H01H 89/06

(57) ABSTRACT

A circuit breaker assembly for a small commercial establishment or residence, wherein the circuit breaker assembly has a coordinated backup fuse within its standard enclosure to protect against failure of the trip mechanism of the circuit breaker assembly to open.

### REFERENCE TO PENDING PRIOR PATENT APPLICATION

This patent application claims benefit of pending prior U.S. Provisional Patent Application Ser. No. 62/023,351, filed Jul. 11, 2014 by John K. Grady for INHERENTLY FAIL-SAFE CIRCUIT BREAKER (Attorney's Docket No. 14043P-PRO-001; GRADY-4 PROV), which patent application is hereby incorporated herein by reference.

### FIELD OF INVENTION

This invention relates to electrical circuit breakers in general, and more particularly to small commercial establishment and residential circuit breakers.

### BACKGROUND OF THE INVENTION

Since the very beginnings of central electric power distribution to small commercial establishments and residences, circa 1890, a narrow section of conductor (a “limiter”), or later a short length of low melting point metal such as a tin-solder alloy (a “fuse”), was employed in series to protect against excessive current flow (“overloads”) in small branch circuits. Such excessive current flow (overloads) could lead to overheating in the branch circuits and fire.

The fuse, so-called since it would “fuse” or melt at a certain calibrated level of current, evolved to Edison screw-based, plug-type fuses (typically up to 30 Amperes, or “30 A”) and to snap-in, cartridge-type fuses (typically to 100 A or more).

The simple and effective design of a fuse ensures that it will always work, and the original problem with interchanging Edison screw-based, plug-type fuses rated from 10 A to 30 A was solved with non-interchangeable, value-type “S” Edison fuses, mandated since the mid-20th century by the National Electric Code.

While mechanical circuit breakers (magnetic-based and/or thermal-based) have long been in use in high current, high voltage and high power applications, these circuit breakers were not made in small sizes, to replace “home” screw-based, plug-type fuses, until the 1950s.

At that time, screw-based, plug-type fuses came to be regarded as somewhat “old fashioned”, perhaps partially due to the fact that a fuse must be replaced after being subjected to overload conditions whereas a circuit breaker simply needs to be reset when subjected to overload conditions; and perhaps partially due to marketing campaigns driven by those who profited from the sale of circuit breakers (which are more expensive than fuses, typically by a factor of ten or more); and perhaps partially due to unknowing real estate brokers citing circuit breakers as a positive improvement over traditional fuses.

The inherently fail-safe nature of fuses was lost in this discussion, and mechanical circuit breakers (magnetic-based and/or thermal-based) are now the primary protective devices used at the electric service entrance of branch circuits in small commercial establishments and residences.

Today, there are hundreds of millions of older mechanical circuit breakers currently in service, and some manufacturers have used unprotected steel parts and steel springs inside the circuit breakers. When these circuit breakers are installed in damp conditions (e.g., a damp basement), the circuit breakers can corrode internally, locking the mechanical trip mechanism of the circuit breaker in the “closed” (i.e., current-passing) position—and hence disabling the protection against current overloads.

A test of thousands of mechanical circuit breakers has shown that a high percentage (over 30%) of one brand of circuit breaker is essentially inoperable due to the aforementioned corrosion-based degradation of the circuit breaker.

Applicant himself has experienced three separate incidents of serious electrical damage due to the failure of a mechanical circuit breaker to “open” (i.e., to stop the flow of current) under overload conditions. Any one of these circuit breaker failures could have resulted in a major fire. The defective circuit breakers were taken apart and examined, and were found to have rusted internal parts which prevented the mechanical trip mechanism of the circuit breaker from opening under overload conditions. Applicant is convinced that many mysterious fires of “electrical origin” may be due to corrosion-based degradation of mechanical circuit breakers.

The total impedance (Z) of a long branch circuit, combined with supply impedance, can approach 0.5-1 ohm. Given this, and given the 120 Volt service common to small commercial establishments and residences, currents of 100-200 A can be experienced if a circuit breaker fails, which can ignite a fire all along a typical 14 gauge wire (i.e., by turning the wire “red hot”). Smaller wires, such as lamp cords, will ignite a fire even faster.

Modern “electronically-controlled” circuit breakers also typically open the circuit mechanically and are still subject to the aforementioned corrosion issues. As the mechanical aspects of these “electronically-controlled” circuit breakers age, they can also degrade, particularly under damp conditions, and operability of 50 or 100 years is, at best, questionable.

The primary object of the present invention is to prevent the occurrence of overload currents in small commercial establishment and residential electrical circuits due to circuit breaker malfunction, regardless of the cause of the circuit breaker malfunction (which may include circuit breaker malfunction in aging mechanical circuit breakers, modern electronically-controlled circuit breakers, ground fault interrupters and arc fault interrupters).

### SUMMARY OF THE INVENTION

In accordance with the present invention, there is provided an inherently fail-safe circuit breaker assembly having a fail-safe protector (e.g., a fuse) incorporated within the circuit breaker assembly, wherein the fail-safe protector (e.g., fuse) is configured to allow the occurrence of an acceptable overload without terminating current flow, so that the trip mechanism of the circuit breaker can operate in both “instant trip” mode (generally tripping at approximately 150 A), or in “long-term overload trip” mode (generally tripping at overloads of 20-30 A occurring for 20-30 seconds) without the fail-safe protector (e.g., fuse) terminating current flow (e.g., without the fuse “blowing”).

However, in the event that the circuit breaker malfunctions (e.g., the trip mechanism of the circuit breaker jams or fails to operate for any reason), the fail-safe protector (e.g., fuse) will operate (e.g., “blow”), especially on sustained high currents, e.g., 100 A or more for 10 seconds.

This will positively prevent a branch circuit of a small commercial establishment or residence from becoming a source of ignition.

The fail-safe protector (e.g., fuse) can be easily included in the housing of a conventional circuit breaker, thereby providing a novel inherently fail-safe circuit breaker assembly which provides “inherently safe” protection from an overload current in a malfunctioning circuit breaker. The fail-safe protector (e.g., fuse) in the novel inherently fail-safe circuit breaker assembly will protect against steady state short circuits, even if the mechanical parts of the circuit breaker have been subjected to degradation.

It should be noted that a long-term overheat situation (e.g., 30 A on a 14 gauge wire, for 20-30 seconds) in combination with a jammed circuit breaker can typically progress to the point where the adjacent wires in a power line or power cord melt to each other, resulting in a short circuit and the creation of approximately 100 A or more currents, so even a larger capacity fail-safe protector (e.g., fuse) is still highly protective.

The “time-to-blow” of the fail-safe protector (e.g., fuse) can also be coordinated with each circuit breaker size (or range of sizes), as determined by an engineering study.

In one preferred form of the present invention, there is provided a circuit breaker assembly for a small commercial establishment or residence that has a coordinated backup fuse within its standard enclosure to protect against failure of the trip mechanism of the circuit breaker assembly to open.

In another preferred form of the present invention, there is provided an inherently fail-safe circuit breaker assembly comprising:

a housing;

an electrical input mounted to said housing;

an electrical output mounted to said housing;

a circuit breaker trip mechanism mounted to said housing and electrically connected between said electrical input and said electrical output, wherein said circuit breaker trip mechanism is configured to interrupt current flow between said electrical input and said electrical output when (i) the electrical current through said circuit breaker trip mechanism exceeds a first predetermined current level, and (ii) the electrical current through said circuit breaker trip mechanism exceeds a second predetermined current level for a first predetermined period of time; and

a fail-safe protector mounted to said housing and electrically connected between said electrical input and said electrical output, wherein said fail-safe protector is configured to interrupt current flow between said electrical input and said electrical output when the electrical current through said fail-safe protector (i) exceeds a third predetermined current level, or (ii) exceeds a fourth predetermined current level for a second predetermined period of time.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing a novel inherently fail-safe circuit breaker assembly formed in accordance with the present invention; and

FIG. 2 is a schematic view showing a trip mechanism of a circuit breaker and a fail-safe protector (e.g., fuse) which is connected “upstream” of the trip mechanism of the circuit breaker, between the trip mechanism of the circuit breaker and the power source.

### DETAILED DESCRIPTION QF THE PREFERRED EMBODIMENTS

The present invention comprises the provision and use of a novel inherently fail-safe circuit breaker assembly. In one preferred form of the present invention, the invention comprises the provision of a fail-safe protector (e.g., fuse) added within every branch in a circuit breaker housing, with the fail-safe protector (e.g., fuse) being located “upstream” of the standard trip mechanism of the circuit breaker. Each fail-safe protector (e.g., fuse) is configured to tolerate an acceptable overload current without terminating current flow, so as to allow the trip mechanism of the circuit breaker to operate in both “instant trip” mode (generally tripping at approximately 150 A) or in “long-term overload trip” mode (generally tripping at overloads of 20-30 A occurring for 20-30 seconds) without the fail-safe protector (e.g., fuse) terminating current flow (e.g., without the fuse blowing).

However, in the event that the circuit breaker malfunctions (e.g., the trip mechanism of the circuit breaker jams or fails to operate for any reason), the fail-safe protector (e.g., fuse) will operate (e.g., the fuse will “blow”), especially on sustained high currents, e.g., 100 A or more for 10 seconds.

This will positively prevent the branch circuit of a small commercial establishment or residence from becoming a source of ignition.

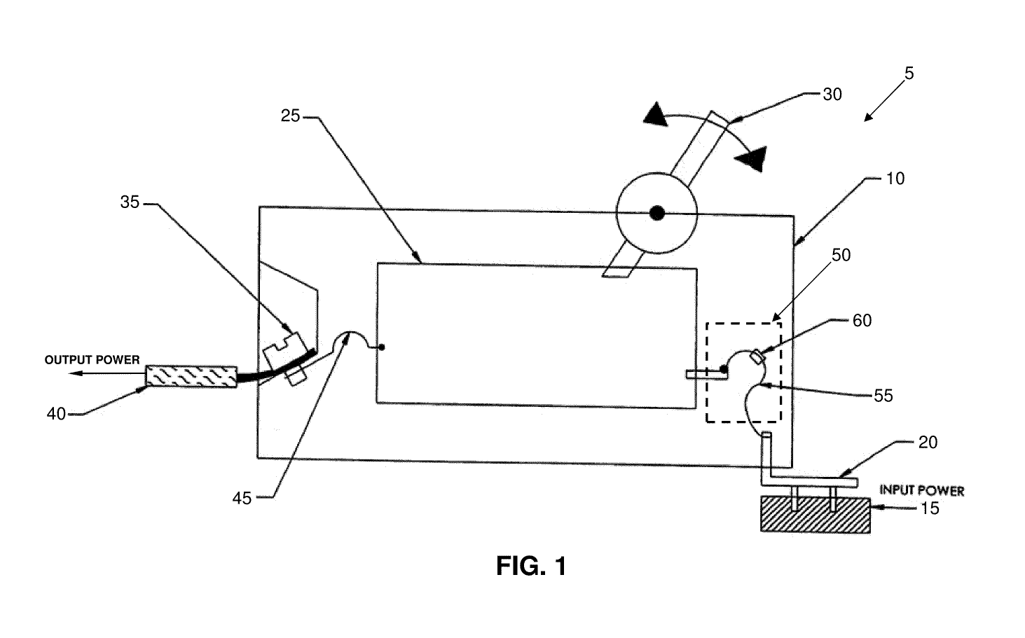

Looking now at FIG. 1, there is shown a novel inherently fail-safe circuit breaker assembly 5 formed in accordance with the present invention. Inherently fail-safe circuit breaker assembly 5 is housed in a standard circuit breaker enclosure (housing) 10 and “plugged onto” a live bus bar 15 by a foot or bolt 20, i.e., the electrical power enters inherently fail-safe circuit breaker assembly 5 at foot 20.

The electric current then passes through a “trip mechanism” 25 of inherently fail-safe circuit breaker assembly 5. Trip mechanism 25 is a conventional trip mechanism of the sort well known in the art of circuit breakers, i.e., inside trip mechanism 25 are springs (not shown) to store mechanical energy input by toggle 30 when inherently fail-safe circuit breaker assembly 5 is set to its “on” (i.e., current passing) position (or state). Also inside trip mechanism 25 is a small coil (not shown) with an iron core forming the “instant trip” aspect (that “jumps up” and trips at an “instant trip” current threshold, e.g., 100 A), and a heater element that unbends a bimetal strip for tripping long-term heating at smaller current overloads. Such construction details are well known in the art of circuit breakers and are not shown in FIG. 1 for clarity. If desired, electronic trip devices may also be present in trip mechanism 25.

After the electrical current passes through trip mechanism 25, the electrical current leaves inherently fail-safe circuit breaker assembly 5 by screw terminal 35 and wire 40. Inherently fail-safe circuit breaker assembly 5 is rated, e.g., “15 A” or “20 A”, to protect wire 40 from currents over 15 A or 20 A, in the case of a #14 or #12 AWG (American Wire Gauge) copper wire.

The electrical current passes from trip mechanism 25 to screw terminal 35 and wire 40 through a lead wire or stamped metal piece 45.

In accordance with the present invention, there is inventively added a fail-safe protector 50 between trip mechanism 25 and foot 20 and live bus bar 15. In one preferred form of the invention, fail-safe protector 50 comprises a fusible wire 55 and a heat sink 60, coordinated to melt fusible wire 55 if trip mechanism 25 fails to open when an excessive level of current passes through the assembly for a selected amount of time By way of example but not limitation, fail-safe protector 50 is configured to interrupt current flow in the event that trip mechanism 25 fails to trip when current flow exceeds the trip mechanism's “instant trip” threshold (e.g., 150 A), or in the event that trip mechanism 25 fails to trip when current flow exceeds the current and time thresholds of the trip mechanism's long-term overload trip mode (e.g., when the current flow exceeds 20-30 A for 20-30 seconds).

In one preferred form of the present invention, fail-safe protector 50 is disposed within housing 10 of inherently fail-safe circuit breaker assembly 5.

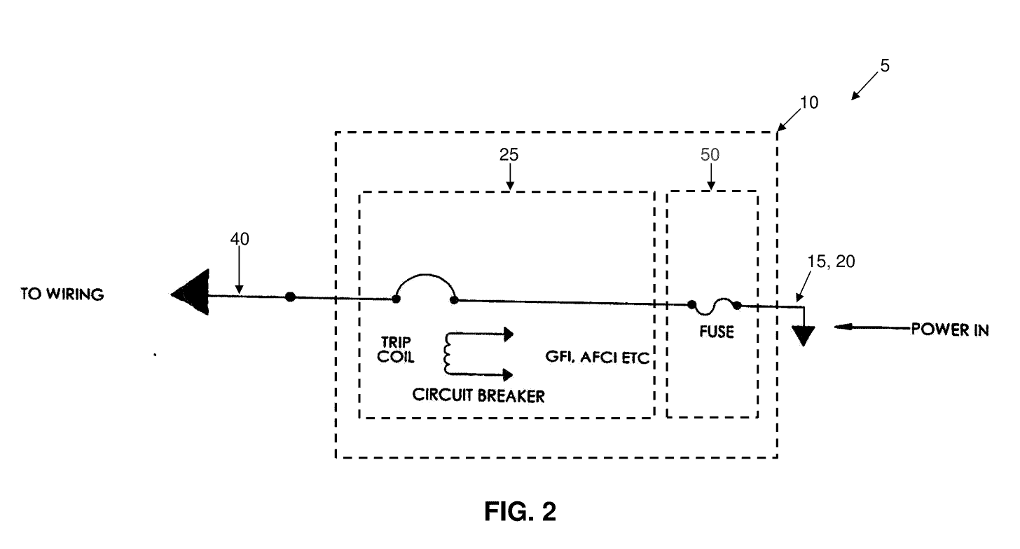

FIG. 2 depicts wire 40 connected to inherently fail-safe circuit breaker assembly 5. Trip mechanism 25 of inherently fail-safe circuit breaker assembly 5 is connected to a fail-safe protector 50 (e.g., fusible wire 55 and heat sink 60), preferably located within housing 10 of the inherently fail-safe circuit breaker assembly 5, prior to being connected to the electrical source (“power in”).

To some extent, the present invention can be thought of as being a circuit breaker for a small commercial establishment or residence that has a coordinated backup fuse within its standard enclosure (housing) so as to protect against a failure of the trip mechanism of the circuit breaker to open. The inherently fail-safe circuit breaker assembly 5 (e.g., a conventional circuit breaker with backup fuse) is intended to be OEM equipment. Electricians may, however, physically retrofit older circuit breakers by placing the fail-safe protector 50 (e.g., a fuse) in series with the conventional circuit breaker.

The inherently fail-safe circuit breaker assembly 5 is preferably uniquely marked on its visible surface to show that it is an inherently fail-safe circuit breaker assembly.

For practical purposes, the protection afforded by the present invention will not fail as long as fail-safe protector 50 (e.g., fusible wire 55 and heat sink 60) is properly connected in series with the trip mechanism of a conventional circuit breaker.

### Additional Embodiments

In accordance with the present invention, there could also be a combination or grouping of several conventional circuit breakers connected with an upstream fail-safe protector (e.g., a fusible or sensing device) designed to protect against failure of any of the downstream circuit breakers. By way of example but not limitation, fail-safe circuit protection can also be provided by subdividing a typical residential service panel into, for example, four 60 A subsections, each protected by a suitable time delay fuse while leaving the individual circuit breakers as they are.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A circuit breaker assembly for a small commercial establishment or residence, wherein the circuit breaker assembly has a coordinated backup fuse within its standard enclosure to protect against failure of the trip mechanism of the circuit breaker assembly to open.

2. A circuit breaker assembly according to claim 1 wherein the circuit breaker assembly is designed to physically retrofit older circuit breakers by direct replacement.

3. A circuit breaker assembly according to claim 1 wherein the circuit breaker assembly is uniquely marked on its visible surface to show it is an inherently fail-safe circuit breaker.

4. A circuit breaker assembly according to claim 2 wherein the circuit breaker assembly is uniquely marked on its visible surface to show it is an inherently fail-safe circuit breaker.

5. A system comprising a combination, connection or grouping of a plurality of conventional circuit breakers and an upstream fail-safe protector designed to protect against failure of any downstream circuit breaker.

6. A system according to claim 5 wherein the fail-safe protector comprises a fuse.

7. An inherently fail-safe circuit breaker assembly comprising:
a housing;
an electrical input mounted to said housing;
an electrical output mounted to said housing;
a circuit breaker trip mechanism mounted to said housing and electrically connected between said electrical input and said electrical output, wherein said circuit breaker trip mechanism is configured to interrupt current flow between said electrical input and said electrical output when (i) the electrical current through said circuit breaker trip mechanism exceeds a first predetermined current level, and (ii) the electrical current through said circuit breaker trip mechanism exceeds a second predetermined current level for a first predetermined period of time; and
a fail-safe protector mounted to said housing and electrically connected between said electrical input and said electrical output, wherein said fail-safe protector is configured to interrupt current flow between said electrical input and said electrical output when the electrical current through said fail-safe protector (i) exceeds a third predetermined current level, or (ii) exceeds a fourth predetermined current level for a second predetermined period of time.

8. An inherently fail-safe circuit breaker assembly according to claim 7 wherein said first predetermined current level is 150 A.

9. An inherently fail-safe circuit breaker assembly according to claim 7 wherein said first predetermined current level is 100 A.

10. An inherently fail-safe circuit breaker assembly according to claim 7 wherein said second predetermined current level is 30 A and said first predetermined period of time is 20 seconds.

11. An inherently fail-safe circuit breaker assembly according to claim 7 wherein said second predetermined current level is 20 A and said first predetermined period of time is 30 seconds.

12. An inherently fail-safe circuit breaker assembly according to claim 7 wherein said third predetermined current level is greater than 150 A.

13. An inherently fail-safe circuit breaker assembly according to claim 7 wherein said third predetermined current level is greater than 100 A.

14. An inherently fail-safe circuit breaker assembly according to claim 7 wherein said fourth predetermined current level is greater than 30 A and said second predetermined period of time is greater than 20 seconds.

15. An inherently fail-safe circuit breaker assembly according to claim 7 wherein said fourth predetermined current level is greater than 20 A and said second predetermined period of time is greater than 30 seconds.
